(19) United States
(12) Patent Application Publication
(10) Pub. No.: US 2023/0127928 A1
(43) Pub. Date: Apr. 27, 2023

(54) CARRIER SWITCHING FOR A PHYSICAL UPLINK CONTROL CHANNEL

(71) Applicant: QUALCOMM Incorporated, San Diego, CA (US)

(72) Inventors: Konstantinos DIMOU, New York City, NY (US); Yan ZHOU, San Diego, CA (US); Tao LUO, San Diego, CA (US)

(21) Appl. No.: 17/934,762

(22) Filed: Sep. 23, 2022

Related U.S. Application Data
(60) Provisional application No. 63/262,909, filed on Oct. 22, 2021.

(51) Int. Cl. H04W 72/12; H04L 1/08; H04W 24/08

(52) U.S. Cl. CPC H04W 72/1263; H04W 72/1284; H04L 1/08; H04W 24/08

(57) ABSTRACT

Various aspects of the present disclosure generally relate to wireless communication. In some aspects, a user equipment (UE) may receive, from a network, a configuration message indicating to switch carriers for a physical uplink control channel (PUCCH). Accordingly, the UE may transmit one or more repetitions of a PUCCH signal on a second carrier rather than a first carrier based on a final repetition, of the one or more repetitions, on the second carrier being scheduled earlier in time than a final repetition on the first carrier. Numerous other aspects are described.

### CROSS-REFERENCE TO RELATED APPLICATION

This patent application claims priority to U.S. Provisional Patent Application No. 63/262,909, filed on Oct. 22, 2021, entitled “CARRIER SWITCHING FOR A PHYSICAL UPLINK CONTROL CHANNEL,” and assigned to the assignee hereof. The disclosure of the prior application is considered part of and is incorporated by reference in this patent application.

### FIELD OF THE DISCLOSURE

Aspects of the present disclosure generally relate to wireless communication and to techniques and apparatuses for switching carriers for a physical uplink control channel.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to an apparatus for wireless communication at a user equipment (UE). The apparatus may include a memory and one or more processors coupled to the memory. The one or more processors may be configured to receive, from a network, a configuration message indicating to switch carriers for a physical uplink control channel (PUCCH). The one or more processors may be further configured to transmit one or more repetitions of a PUCCH signal on a second carrier rather than a first carrier based on a final repetition, of the one or more repetitions, on the second carrier being scheduled earlier in time than a final repetition on the first carrier.

Some aspects described herein relate to an apparatus for wireless communication at one or more network cells. The apparatus may include a memory and one or more processors coupled to the memory. The one or more processors may be configured to transmit, to a UE, a configuration message indicating to switch carriers for a PUCCH. The one or more processors may be further configured to monitor for one or more repetitions of a PUCCH signal on a second carrier rather than a first carrier based on a final repetition, of the one or more repetitions, on the second carrier being scheduled earlier in time than a final repetition on the first carrier.

Some aspects described herein relate to a non-transitory computer-readable medium that stores a set of instructions for wireless communication by a UE. The set of instructions, when executed by one or more processors of the UE, may cause the UE to receive, from a network, a configuration message indicating to switch carriers for a PUCCH. The set of instructions, when executed by one or more processors of the UE, may further cause the UE to transmit one or more repetitions of a PUCCH signal on a second carrier rather than a first carrier based on a final repetition, of the one or more repetitions, on the second carrier being scheduled earlier in time than a final repetition on the first carrier.

Some aspects described herein relate to a non-transitory computer-readable medium that stores a set of instructions for wireless communication by a one or more instructions that, when executed by one or more processors of one or more network cells. The set of instructions, when executed by one or more processors of the one or more network cells, may cause the one or more network cells to transmit, to a UE, a configuration message indicating to switch carriers for a PUCCH. The set of instructions, when executed by one or more processors of the one or more network cells, may further cause the one or more network cells to monitor for one or more repetitions of a PUCCH signal on a second carrier rather than a first carrier based on a final repetition, of the one or more repetitions, on the second carrier being scheduled earlier in time than a final repetition on the first carrier.

Some aspects described herein relate to an apparatus for wireless communication. The apparatus may include means for receiving, from a network, a configuration message indicating to switch carriers for a PUCCH. The apparatus may include means for transmitting one or more repetitions of a PUCCH signal on a second carrier rather than a first carrier based on a final repetition, of the one or more repetitions, on the second carrier being scheduled earlier in time than a final repetition on the first carrier.

Some aspects described herein relate to an apparatus for wireless communication. The apparatus may include means for transmitting, to a UE, a configuration message indicating to switch carriers for a PUCCH. The apparatus may include means for monitoring for one or more repetitions of a PUCCH signal on a second carrier rather than a first carrier based on a final repetition, of the one or more repetitions, on the second carrier being scheduled earlier in time than a final repetition on the first carrier.

Some aspects described herein relate to a method of wireless communication performed by a UE. The method may include receiving, from a network, a configuration message indicating to switch carriers for a PUCCH. The method may include transmitting one or more repetitions of a PUCCH signal on a second carrier rather than a first carrier based on a final repetition, of the one or more repetitions, on the second carrier being scheduled earlier in time than a final repetition on the first carrier.

Some aspects described herein relate to a method of wireless communication performed by one or more network cells. The method may include transmitting, to a UE, a configuration message indicating to switch carriers for a PUCCH. The method may include monitoring for one or more repetitions of a PUCCH signal on a second carrier rather than a first carrier based on a final repetition, of the one or more repetitions, on the second carrier being scheduled earlier in time than a final repetition on the first carrier.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment in a wireless network, in accordance with the present disclosure.

FIG. 3 is a diagram illustrating an example disaggregated base station architecture, in accordance with the present disclosure.

FIGS. 4, 5, 6, and 7 are diagrams illustrating examples associated with switching carriers for a physical uplink control channel (PUCCH), in accordance with the present disclosure.

FIG. 8 is a diagram illustrating an example associated with switching carriers associated with different subcarrier spacings for a PUCCH, in accordance with the present disclosure.

FIGS. 9 and 10 are diagrams illustrating example processes associated with switching carriers for a PUCCH, in accordance with the present disclosure.

FIGS. 11 and 12 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

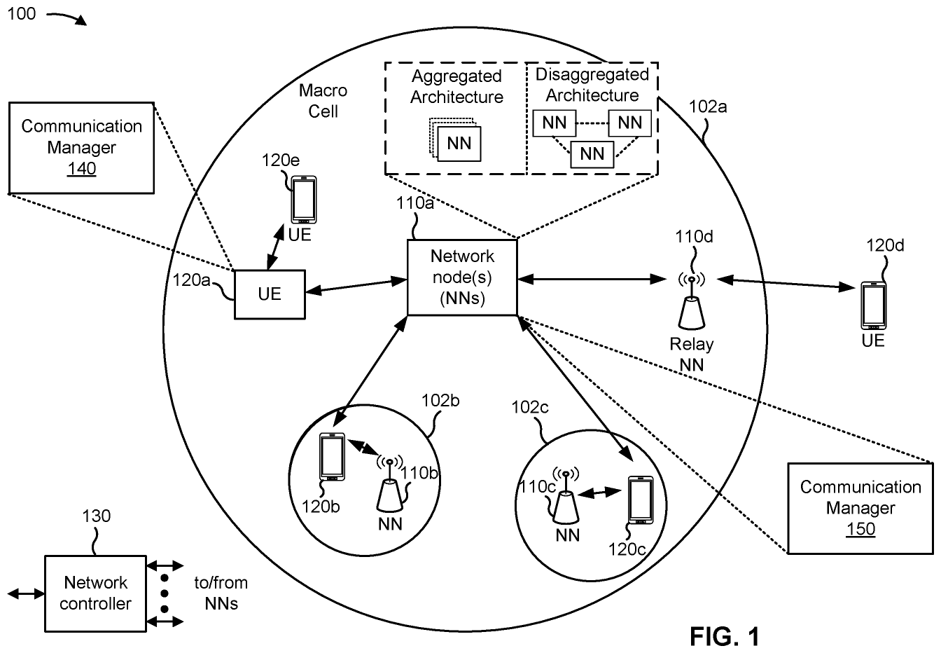

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive (e.g., from a network including the network node 110) a configuration message indicating to switch carriers for a physical uplink control channel (PUCCH), and transmit one or more repetitions of a PUCCH signal on a second carrier rather than a first carrier based on a final repetition, of the one or more repetitions, on the second carrier being scheduled earlier in time than a final repetition on the first carrier. Additionally, or alternatively, the communication manager 140 may perform one or more other operations described herein.

In some aspects, the network node 110 may include a communication manager 150. As described in more detail elsewhere herein, the communication manager 150 may transmit (e.g., to the UE 120) a configuration message indicating to switch carriers for a PUCCH, and monitor for one or more repetitions of a PUCCH signal on a second carrier rather than a first carrier based on a final repetition, of the one or more repetitions, on the second carrier being scheduled earlier in time than a final repetition on the first carrier. Additionally, or alternatively, the communication manager 150 may perform one or more other operations described herein. Although depicted as associated with a single network node, the communication manager 150 may be associated with a plurality of network nodes (e.g., associated with a source cell communicating with the UE 120 on the first carrier and a target cell communication with the UE 120 on the second carrier).

As indicated above, FIG. 1 is provided as an example. Other examples may differ from what is described with regard to FIG. 1.

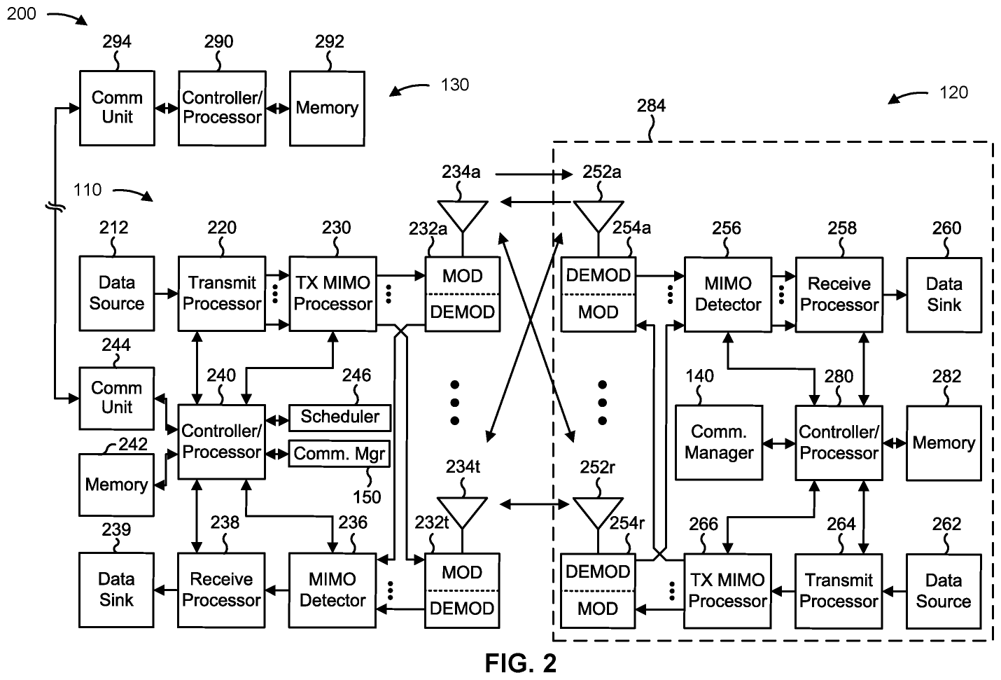

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

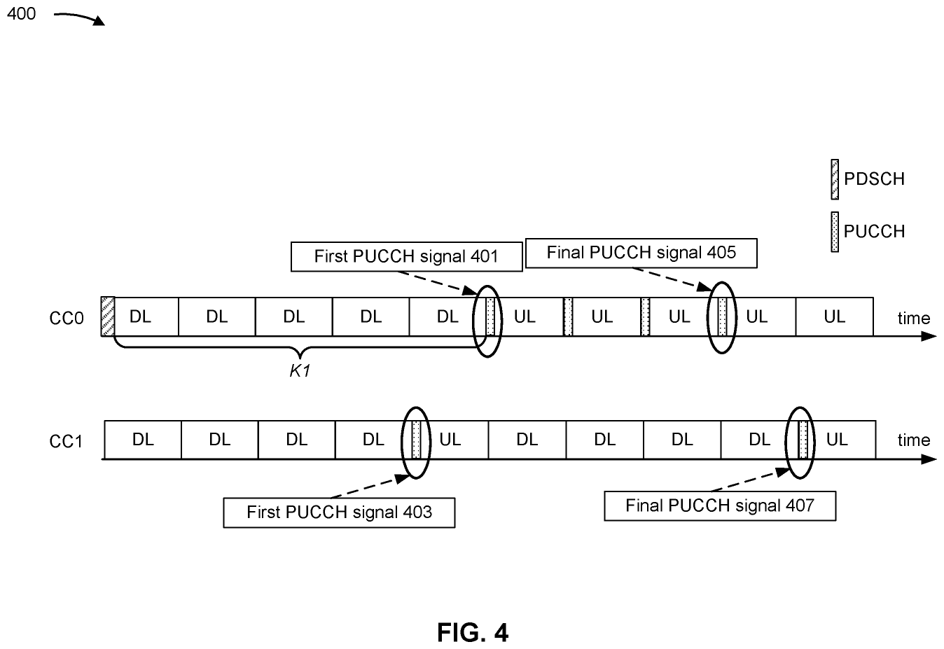

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-12).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-12).

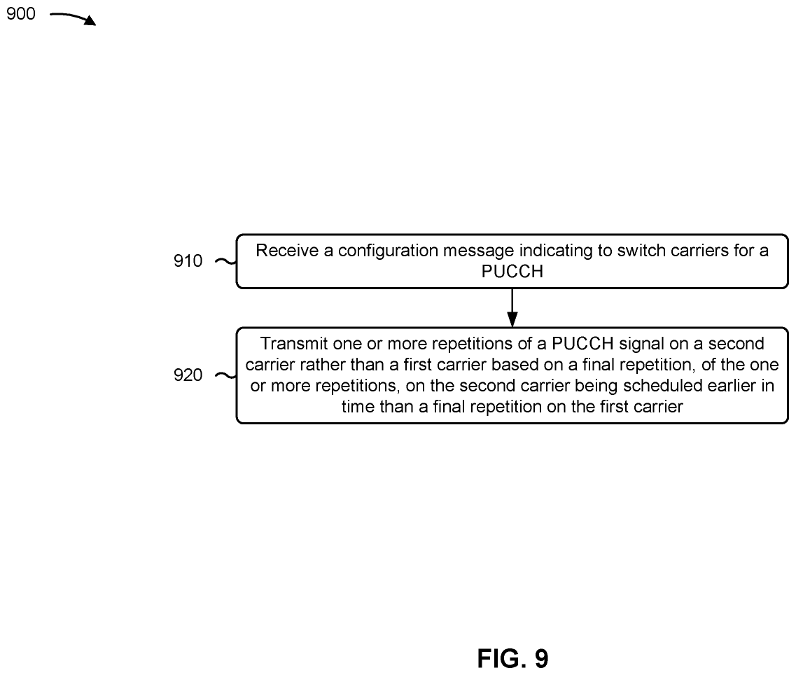

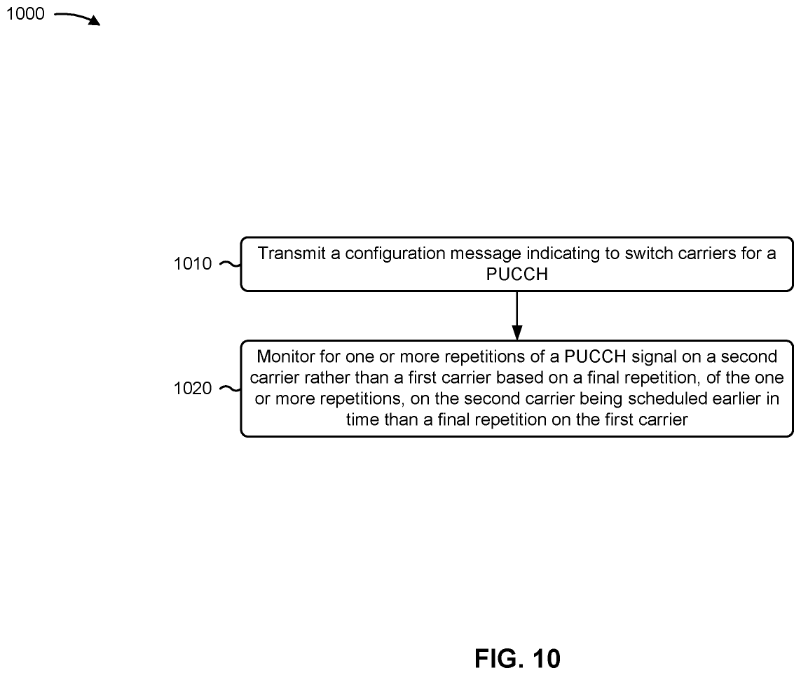

The controller/processor 240 of the network node 110, the controller/processor 280 of the UE 120, and/or any other component(s) of FIG. 2 may perform one or more techniques associated with switching carriers for a PUCCH, as described in more detail elsewhere herein. For example, the controller/processor 240 of the network node 110, the controller/processor 280 of the UE 120, and/or any other component(s) of FIG. 2 may perform or direct operations of, for example, process 900 of FIG. 9, process 1000 of FIG. 10, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 900 of FIG. 9, process 1000 of FIG. 10, and/or other processes as described herein. In some examples, executing instructions may include running the instructions, converting the instructions, compiling the instructions, and/or interpreting the instructions, among other examples.

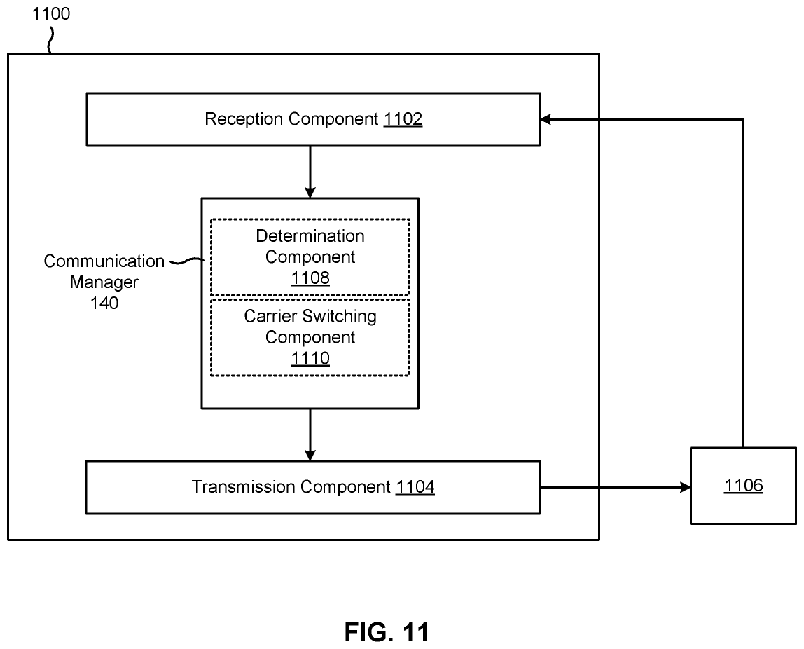

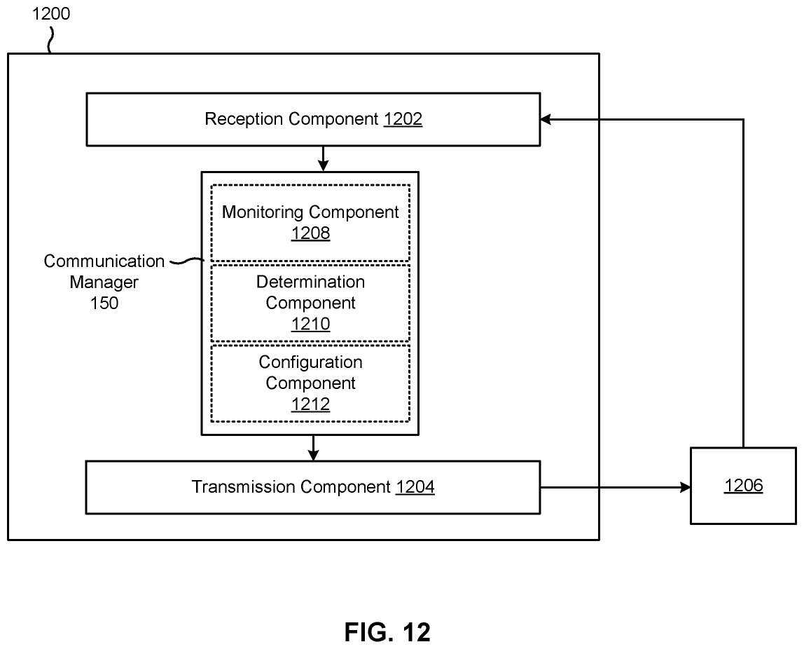

In some aspects, a UE (e.g., the UE 120 and/or apparatus 1100 of FIG. 11) may include means for receiving, from a network (e.g., including one or more network nodes 110 and/or one or more apparatuses 1200 of FIG. 12), a configuration message indicating to switch carriers for a PUCCH; and/or means for transmitting one or more repetitions of a PUCCH signal on a second carrier rather than a first carrier based on a final repetition, of the one or more repetitions, on the second carrier being scheduled earlier in time than a final repetition on the first carrier. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, one or more network cells (e.g., including one or more network nodes 110 and/or one or more apparatuses 1200 of FIG. 12) may include means for transmitting a configuration message indicating to switch carriers for a PUCCH; and/or means for monitoring for one or more repetitions of a PUCCH signal on a second carrier rather than a first carrier based on a final repetition, of the one or more repetitions, on the second carrier being scheduled earlier in time than a final repetition on the first carrier. In some aspects, the means for the one or more network cells to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

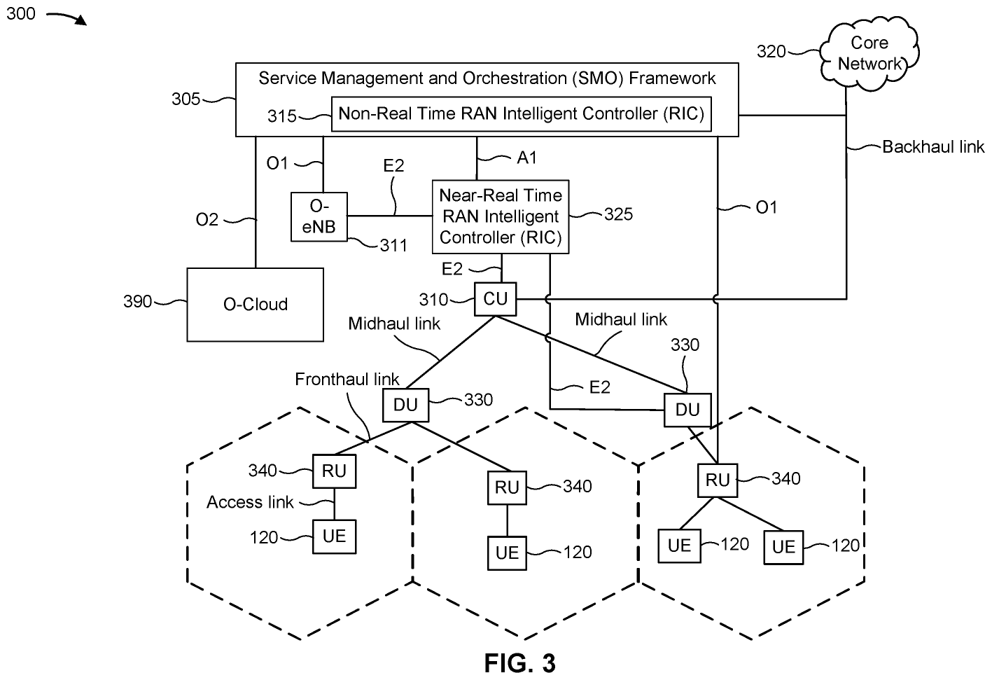

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

When communicating with a UE, a network may use carrier aggregation (CA). For example, a first cell of the network (e.g., including a first network node) may configure a first carrier frequency for transmitting to the UE and receiving from the UE and configure a second carrier frequency to use with a second cell of the network (e.g., including a second network node) for transmitting to the UE and receiving from the UE. Accordingly, the network uses CA to increase throughput to the UE and/or reduce latency in communication with the UE.

To improve reliability, the network may also configure the UE for repetition on a PUCCH. For example, the network may indicate to the UE that the UE should repeat hybrid automatic repeat request (HARM) feedback signals two or more times. The network may indicate to use Type A repetition (e.g., in a same symbol across consecutive slots or sub-slots) or Type B repetition (e.g., in consecutive symbols). As used herein, “slot” refers to a portion of a radio frame (or part of a frame, such as a subframe) within an LTE, 5G, or other wireless communication structure. In some aspects, a slot may include one or more symbols, where “symbol” may refer to an OFDM symbol or other similar symbol within a slot. A “sub-slot” refers to subdivision of a set of slots configured by the network.

When using CA, the network may configure different patterns of downlink and uplink slots (e.g., using an RRC message, such as tdd-UI-DI-ConfigCommon, as defined in 3GPP specifications) for the first carrier as compared with the second carrier. Additionally, the network may indicate to the UE to switch from the first carrier (also called a “source carrier”) to the second carrier (also called a “target carrier”), or from the second carrier (also called a “source carrier”) to the first carrier (also called a “target carrier”), when transmitting PUCCH signals (e.g., HARQ feedback signals). However, the UE will sometimes incur latency when performing carrier switching.

Some techniques and apparatuses described herein enable a UE (e.g., UE 120) to determine when to perform PUCCH carrier switching based on whether a final repetition associated with a target carrier is scheduled earlier in time than a final repetition associated with a source carrier. As a result, the UE 120 reduces latency in completing transmission of PUCCH signal repetitions to a network. Accordingly, the UE 120 conserves power and processing resources by being prepared to enter a low-power state earlier.

FIG. 4 is a diagram illustrating an example 400 associated with switching carriers for a PUCCH, in accordance with the present disclosure. As shown in FIG. 4, example 400 includes a set of slots (e.g., configured for uplink (UL) and downlink (DL)) associated with a first carrier (and thus a first network cell) and a second carrier (and thus a second network cell) used to communicate with a UE (e.g., UE 120). Although described with respect to slots, the description similarly applies to sub-slots.

As shown in FIG. 4, the network may transmit downlink control information (DCI) on a physical downlink shared channel (PDSCH) that schedules a transmission (e.g., of data) from the network to the UE 120 on the first carrier (e.g., in one or more DL slots). Additionally, the DCI may indicate a variable (e.g., represented by K1) that schedules a first transmission of a PUCCH signal (e.g., one or more HARQ feedback signals) associated with the scheduled transmission from the network to the UE 120.

The network may indicate that the UE 120 should repeat the PUCCH signal two or more times (e.g., four times as shown in example 400).

Additionally, the network may transmit, and the UE 120 may receive, a configuration message indicating to switch carriers for the PUCCH. For example, the configuration message may include an RRC message indicating that the UE 120 should perform carrier switching for the PUCCH. In some aspects, the network may additionally transmit, and the UE 120 may additionally receive, at least one of a control element (e.g., a medium access control (MAC) control element (MAC-CE)) or DCI that activates carrier switching on the PUCCH. Although described in connection with switching from the first carrier to the second carrier, the network may alternatively instruct the UE 120 to switch from the second carrier to the first carrier.

In example 400, a first repetition 401 on the first carrier is scheduled later in time than a first repetition 403 on the second carrier. However, a final repetition 405 on the first carrier is scheduled earlier in time than a final repetition 407 on the second carrier. Accordingly, the UE 120 may refrain from switching from the first carrier to the second carrier and transmit the repetitions of the PUCCH signal on the first carrier. Although described in connection with refraining from switching to the second carrier, the UE 120 may alternatively refrain from switching to the first carrier.

By using techniques as described in connection with FIG. 4, the UE 120 reduces latency in completing transmission of PUCCH signal repetitions to the network. Accordingly, the UE 120 conserves power and processing resources by being prepared to enter a low-power state earlier.

As indicated above, FIG. 4 is provided as an example. Other examples may differ from what is described with respect to FIG. 4.

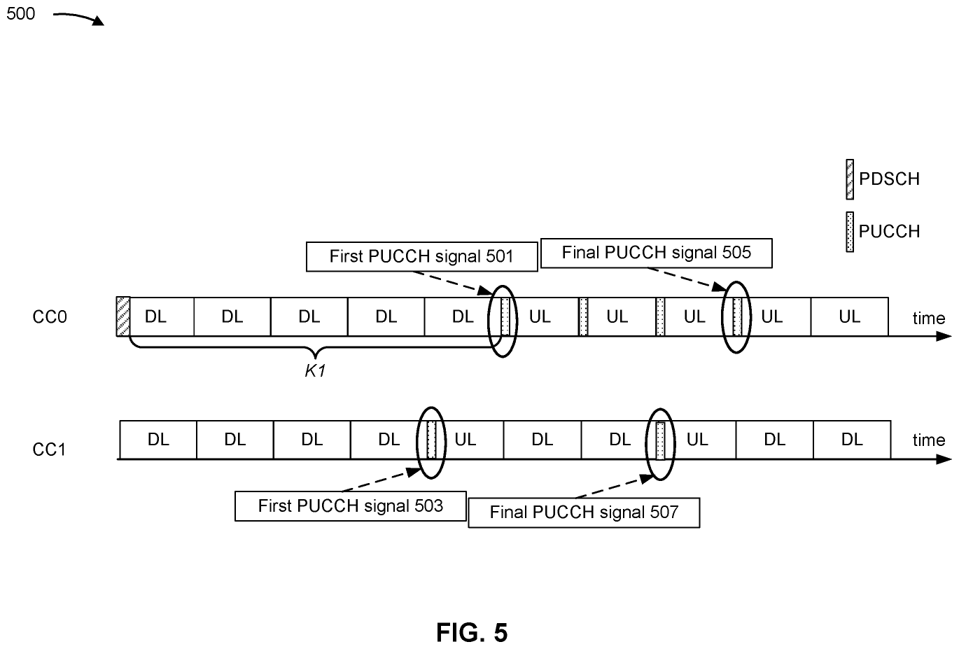

FIG. 5 is a diagram illustrating an example 500 associated with switching carriers for a PUCCH, in accordance with the present disclosure. Example 500 is similar to example 400 except that a first repetition 501 on the first carrier is scheduled later in time than a first repetition 503 on the second carrier, and a final repetition 505 on the first carrier is scheduled later in time than a final repetition 507 on the second carrier. Accordingly, the UE 120 may transmit the repetitions of the PUCCH signal on the second carrier based on the final repetition 507 on the second carrier being scheduled earlier in time than the final repetition 505 on the first carrier.

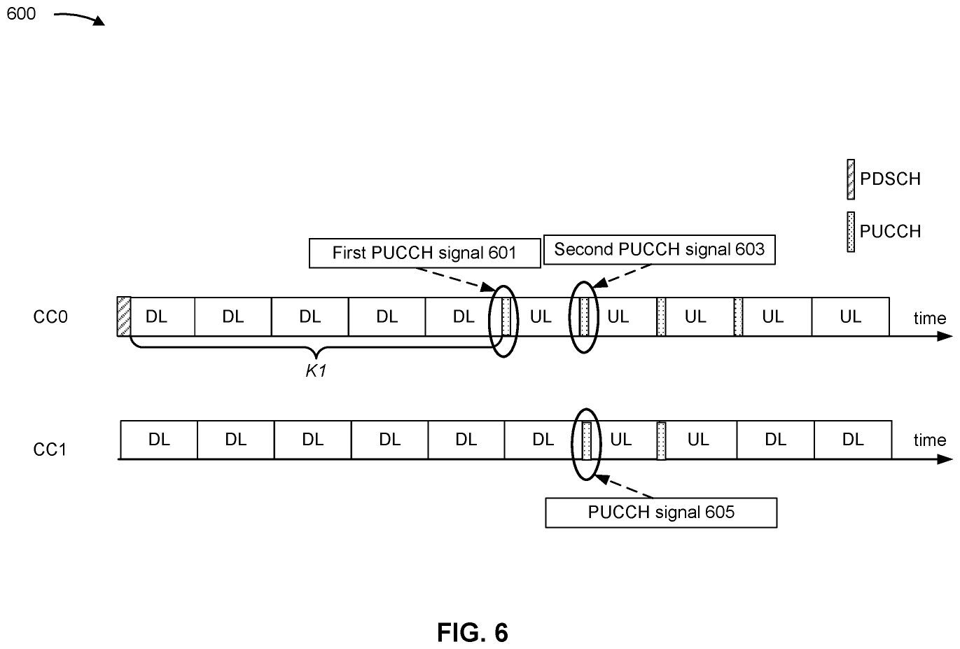

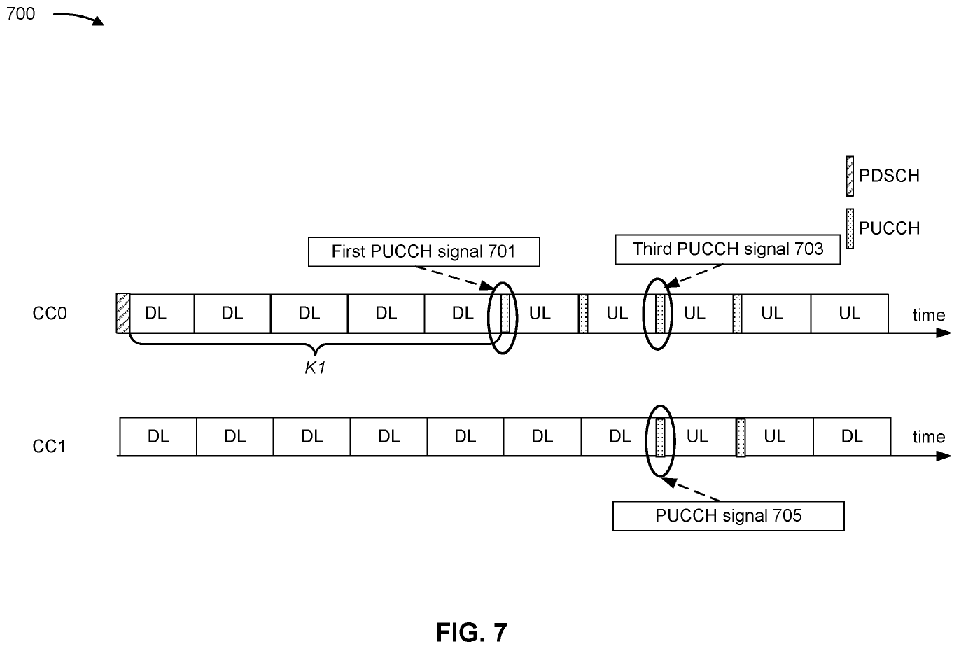

In some aspects, the UE 120 may perform the carrier switching additionally based on a quantity of PUCCH resources on the second carrier satisfying a threshold. For example, the UE 120 may perform the carrier switching only when the network allocates a sufficient quantity of PUCCH resources on the second carrier to transmit all of the scheduled repetitions. As an alternative, the UE 120 may perform the carrier switching when the network allocates a quantity of PUCCH resources on the second carrier such that a percentage threshold of repetitions may be transmitted on the second carrier (e.g., as described in connection with FIG. 6 and/or FIG. 7).

Additionally, or alternatively, the UE 120 may perform the carrier switching additionally based on a repetition type (e.g., repetition type A for slots, repetition type A for sub-slots, or repetition type B) associated with the first carrier matching a repetition type associated with the second carrier. As an alternative, the UE 120 may perform the carrier switching based on the first carrier being associated with repetition type A, and the second carrier being associated with repetition type B. Accordingly, the UE 120 may transmit the scheduled repetitions using repetition type B on the second carrier rather than repetition type A on the first carrier. As an alternative, the UE 120 may perform the carrier switching based on the first carrier being associated with repetition type A per sub-slot, and the second carrier being associated with repetition type A per slot. Accordingly, the UE 120 may transmit the scheduled repetitions in each slot of the second carrier rather than each sub-slot of the first carrier. In some aspects, the UE 120 may mix repetition types on the second carrier. Accordingly, the UE 120 may transmit a first portion of the repetitions of the PUCCH signal on the second carrier using repetition type A, and a second portion of the repetitions of the PUCCH signal on the second carrier using repetition type B.

By using techniques as described in connection with FIG. 5, the UE 120 reduces latency in completing transmission of PUCCH signal repetitions to the network. Accordingly, the UE 120 conserves power and processing resources by being prepared to enter a low-power state earlier.

As indicated above, FIG. 5 is provided as an example. Other examples may differ from what is described with respect to FIG. 5.

FIG. 6 is a diagram illustrating an example 600 associated with switching carriers for a PUCCH, in accordance with the present disclosure. Example 600 is similar to example 500 except that the UE 120 performs carrier switching after the first repetition 601 is transmitted on the first carrier. For example, an N^{th} repetition 603 (a second repetition in example 600) on the first carrier is scheduled later in time than a corresponding repetition 605 on the second carrier. As used herein, A may be referred to as “later in time” when starting later in time than, or at a same time as, B. Similarly, A may be referred to as “earlier in time” when starting earlier in time than, or at a same time as, B. Additionally, a final repetition on the first carrier is later in time than a final repetition on the second carrier, so the UE 120 may perform carrier switching for the second repetition and subsequent repetitions. Accordingly, the UE 120 transmits the repetitions of the PUCCH signal on the second carrier based on a second (or later) repetition 505 on the second carrier being scheduled earlier in time than a corresponding repetition 503 on the first carrier.

In some aspects, the network may indicate a slot threshold such that the UE 120 performs carrier switching based on a later repetition on the second carrier, that satisfies the slot threshold, being scheduled earlier in time than a corresponding repetition on the first carrier. For example, if the network indicates a threshold of three, the UE 120 may perform carrier switching only when a first repetition, a second repetition, or a third repetition on the second carrier are scheduled earlier in time than a corresponding repetition on the first carrier.

By using techniques as described in connection with FIG. 6, the UE 120 reduces latency in completing transmission of PUCCH signal repetitions to the network. Accordingly, the UE 120 conserves power and processing resources by being prepared to enter a low-power state earlier.

As indicated above, FIG. 6 is provided as an example. Other examples may differ from what is described with respect to FIG. 6.

FIG. 7 is a diagram illustrating an example 700 associated with switching carriers for a PUCCH, in accordance with the present disclosure. Example 700 is similar to example 500 except that the UE 120 performs carrier switching after the first repetition 701 is transmitted on the first carrier. For example, an N^{th} repetition 703 (a third repetition in example 700) on the first carrier is scheduled later in time than a corresponding repetition 705 on the second carrier. Additionally, a final repetition on the first carrier is later in time than a final repetition on the second carrier, so the UE 120 may perform carrier switching for the third repetition and subsequent repetitions. Accordingly, the UE 120 transmits the repetitions of the PUCCH signal on the second carrier based on a later repetition 705 on the second carrier being scheduled earlier in time than a corresponding repetition 703 on the first carrier.

In some aspects, the network may indicate a time threshold such that the UE 120 performs carrier switching based on a later repetition on the second carrier is scheduled earlier in time than a corresponding repetition, that satisfies the time threshold associated with a first repetition, on the first carrier. For example, if the network indicates a threshold of 5 milliseconds (ms), the UE 120 may perform carrier switching only when a later repetition on the first carrier, that is at least 5 ms after a first repetition on the first carrier, is scheduled later in time than a corresponding repetition on the second carrier.

By using techniques as described in connection with FIG. 7, the UE 120 reduces latency in completing transmission of PUCCH signal repetitions to the network. Accordingly, the UE 120 conserves power and processing resources by being prepared to enter a low-power state earlier.

As indicated above, FIG. 7 is provided as an example. Other examples may differ from what is described with respect to FIG. 7.

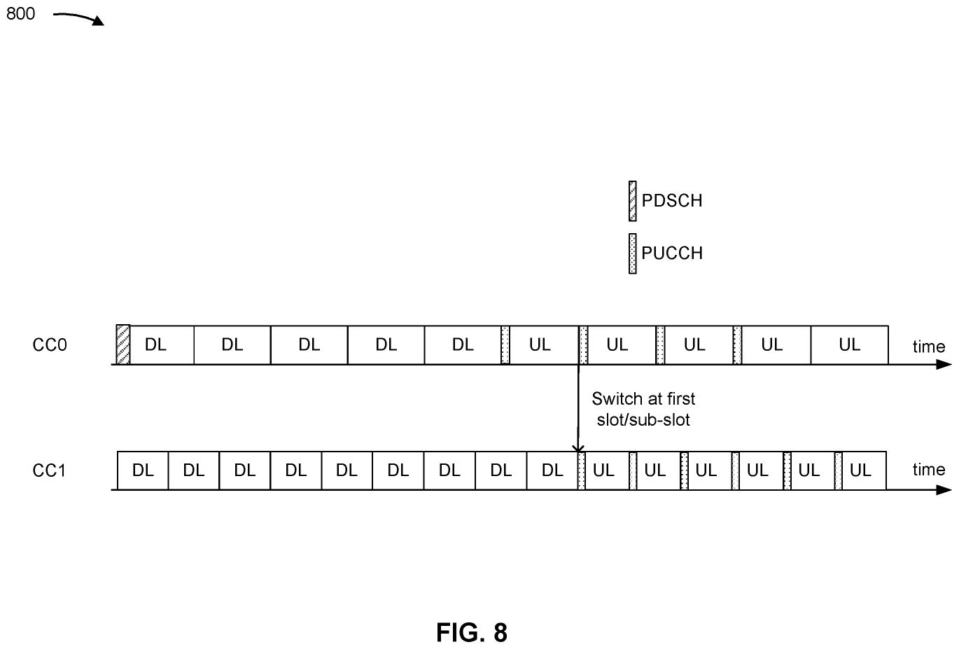

FIG. 8 is a diagram illustrating an example 800 associated with switching carriers associated with different subcarrier spacing (SCSs) for a PUCCH, in accordance with the present disclosure. As shown in FIG. 8, example 800 includes a set of slots (e.g., configured for UL and DL) associated with a first carrier (and thus a first network cell) and a second carrier (and thus a second network cell) used to communicate with a UE (e.g., UE 120). Although described with respect to slots, the description similarly applies to sub-slots.

As shown in FIG. 8, the second carrier is associated with a different SCS than the first carrier. Accordingly, the UE 120 may estimate a quantity of PUCCH repetitions on the second carrier using a quantity of PUCCH repetitions on the first carrier, the SCS associated with the second carrier, and the SCS associated with the first carrier. For example, the UE 120 may multiply a ratio of the SCSs by the quantity of PUCCH repetitions on the first carrier to determine the quantity of PUCCH repetitions on the second carrier. In example 800, the ratio is such that the quantity of PUCCH repetitions on the second carrier is twice the quantity of PUCCH repetitions on the first carrier.

In some aspects, the UE 120 may perform carrier switching based on the quantity of repetitions on the second carrier being fewer than the quantity of repetitions on the first carrier. As a result, the UE 120 may reduce latency and conserve power and processing resources. Additionally, or alternatively, the UE 120 may perform carrier switching based on the quantity of repetitions on the second carrier satisfying a percentage threshold of the quantity of repetitions on the first carrier. For example, the UE 120 may perform carrier switching when the second carrier reduces the quantity of repetitions by the percentage threshold. As an alternative, the UE 120 may perform carrier switching when the second carrier increases the quantity of repetitions by no more than the percentage threshold (e.g., to conserve power and processing resources).

As further shown in FIG. 8, the UE 120 may perform the carrier switching at an earliest available slot or (sub-slot) on the second carrier. For example, the UE 120 may switch carriers even if the UE 120 is in a middle of a slot (or sub-slot) on the first carrier. In some aspects, the UE 120 may begin switching carriers earlier in order to account for a switching time (e.g., due to hardware and/or software delays on the UE 120) such that the UE 120 is ready to transmit on the second carrier at the earliest available slot (or sub-slot).

As indicated above, FIG. 8 is provided as an example. Other examples may differ from what is described with respect to FIG. 8.

FIG. 9 is a diagram illustrating an example process 900 performed, for example, by a UE, in accordance with the present disclosure. Example process 900 is an example where the UE (e.g., UE 120 and/or apparatus 1100 of FIG. 11) performs operations associated with carrier switching for a PUCCH.

As shown in FIG. 9, in some aspects, process 900 may include receiving (e.g., from a network including network node 110 and/or apparatus 1200 of FIG. 12) a configuration message indicating to switch carriers for a PUCCH (block 910). For example, the UE (e.g., using communication manager 140 and/or reception component 1102, depicted in FIG. 11) may receive a configuration message indicating to switch carriers for a PUCCH, as described herein.

As further shown in FIG. 9, in some aspects, process 900 may include transmitting one or more repetitions of a PUCCH signal on a second carrier rather than a first carrier based on a final repetition, of the one or more repetitions, on the second carrier being scheduled earlier in time than a final repetition on the first carrier (block 920). For example, the UE (e.g., using communication manager 140 and/or transmission component 1104, depicted in FIG. 11) may transmit one or more repetitions of a PUCCH signal on a second carrier rather than a first carrier based on a final repetition, of the one or more repetitions, on the second carrier being scheduled earlier in time than a final repetition on the first carrier, as described herein.

Process 900 may include additional aspects, such as any single aspect or any combination of aspects described below and/or in connection with one or more other processes described elsewhere herein.

In a first aspect, the configuration message includes an RRC message.

In a second aspect, alone or in combination with the first aspect, process 900 further includes receiving (e.g., using communication manager 140 and/or reception component 1102) at least one of a control element or DCI that activates carrier switching on the PUCCH.

In a third aspect, alone or in combination with one or more of the first and second aspects, the PUCCH signal includes one or more HARQ feedback signals.

In a fourth aspect, alone or in combination with one or more of the first through third aspects, the one or more repetitions of the PUCCH signal are transmitted on the second carrier further based on a first repetition, of the one or more repetitions, on the second carrier being scheduled earlier in time than a first repetition on the first carrier.

In a fifth aspect, alone or in combination with one or more of the first through fourth aspects, the one or more repetitions of the PUCCH signal are transmitted on the second carrier further based on a quantity of PUCCH resources on the second carrier satisfying a threshold.

In a sixth aspect, alone or in combination with one or more of the first through fifth aspects, the threshold is based on a percentage of a quantity of repetitions on the first carrier.

In a seventh aspect, alone or in combination with one or more of the first through sixth aspects, process 900 includes determining (e.g., using communication manager 140 and/or determination component 1108, depicted in FIG. 11) a quantity of the one or more repetitions on the second carrier based on a quantity of repetitions on the first carrier, an SCS associated with the second carrier, and an SCS associated with the first carrier.

In an eighth aspect, alone or in combination with one or more of the first through seventh aspects, the one or more repetitions of the PUCCH signal are transmitted on the second carrier further based on the quantity of the one or more repetitions on the second carrier being fewer than the quantity of repetitions on the first carrier.

In a ninth aspect, alone or in combination with one or more of the first through eighth aspects, the one or more repetitions of the PUCCH signal are transmitted on the second carrier further based on the quantity of the one or more repetitions on the second carrier satisfying a threshold percentage of the quantity of repetitions on the first carrier.

In a tenth aspect, alone or in combination with one or more of the first through ninth aspects, the one or more repetitions on the second carrier are transmitted at an earliest available slot or sub-slot on the second carrier.

In an eleventh aspect, alone or in combination with one or more of the first through tenth aspects, the one or more repetitions of the PUCCH signal are transmitted on the second carrier further based on a second or later repetition, of the one or more repetitions, on the second carrier being scheduled earlier in time than a corresponding repetition on the first carrier.

In a twelfth aspect, alone or in combination with one or more of the first through eleventh aspects, the one or more repetitions of the PUCCH signal are transmitted on the second carrier further based on a repetition that satisfies a time threshold associated with a first repetition, of the one or more repetitions, on the second carrier being scheduled earlier in time than a corresponding repetition on the first carrier.

In a thirteenth aspect, alone or in combination with one or more of the first through twelfth aspects, the one or more repetitions of the PUCCH signal are transmitted on the second carrier further based on a repetition type associated with the first carrier matching a repetition type associated with the second carrier.

In a fourteenth aspect, alone or in combination with one or more of the first through thirteenth aspects, the one or more repetitions of the PUCCH signal are transmitted on the second carrier further based on the first carrier being associated with repetition type A and the second carrier being associated with repetition type B.

In a fifteenth aspect, alone or in combination with one or more of the first through fourteenth aspects, the one or more repetitions of the PUCCH signal are transmitted on the second carrier further based on the first carrier being associated with repetition type A per sub-slot and the second carrier being associated with repetition type A per slot.

In a sixteenth aspect, alone or in combination with one or more of the first through fifteenth aspects, a first portion of the one or more repetitions of the PUCCH signal are transmitted on the second carrier using repetition type A and a second portion of the one or more repetitions of the PUCCH signal are transmitted on the second carrier using repetition type B.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a one or more network cells, in accordance with the present disclosure. Example process 1000 is an example where the one or more network cells (e.g., including network node 110 and/or apparatus 1200 of FIG. 12) performs operations associated with carrier switching for a PUCCH.

As shown in FIG. 10, in some aspects, process 1000 may include transmitting a configuration message indicating to switch carriers for a PUCCH (block 1010). For example, the one or more network cells (e.g., using communication manager 150 and/or transmission component 1204, depicted in FIG. 12) may transmit a configuration message indicating to switch carriers for a PUCCH, as described herein.

As further shown in FIG. 10, in some aspects, process 1000 may include monitoring for one or more repetitions of a PUCCH signal on a second carrier rather than a first carrier based on a final repetition, of the one or more repetitions, on the second carrier being scheduled earlier in time than a final repetition on the first carrier (block 1020). For example, the one or more network cells (e.g., using communication manager 150 and/or monitoring component 1208, depicted in FIG. 12) may monitor for one or more repetitions of a PUCCH signal on a second carrier rather than a first carrier based on a final repetition, of the one or more repetitions, on the second carrier being scheduled earlier in time than a final repetition on the first carrier, as described herein.

Process 1000 may include additional aspects, such as any single aspect or any combination of aspects described below and/or in connection with one or more other processes described elsewhere herein.

In a first aspect, the configuration message includes an RRC message.

In a second aspect, alone or in combination with the first aspect, process 1000 further includes transmitting (e.g., using communication manager 150 and/or transmission component 1204, depicted in FIG. 12) at least one of a control element or DCI that activates carrier switching on the PUCCH.

In a third aspect, alone or in combination with one or more of the first and second aspects, the PUCCH signal includes one or more HARQ feedback signals.

In a fourth aspect, alone or in combination with one or more of the first through third aspects, the one or more repetitions of the PUCCH signal are monitored for on the second carrier further based on a first repetition, of the one or more repetitions, on the second carrier being scheduled earlier in time than a first repetition on the first carrier.

In a fifth aspect, alone or in combination with one or more of the first through fourth aspects, the one or more repetitions of the PUCCH signal are monitored for on the second carrier further based on a quantity of PUCCH resources on the second carrier satisfying a threshold.

In a sixth aspect, alone or in combination with one or more of the first through fifth aspects, the threshold is based on a percentage of a quantity of repetitions on the first carrier.

In a seventh aspect, alone or in combination with one or more of the first through sixth aspects, process 1000 further includes determining (e.g., using communication manager 150 and/or determination component 1210, depicted in FIG. 12) a quantity of the one or more repetitions on the second carrier based on a quantity of repetitions on the first carrier, an SCS associated with the second carrier, and an SCS associated with the first carrier.

In an eighth aspect, alone or in combination with one or more of the first through seventh aspects, the one or more repetitions of the PUCCH signal are monitored for on the second carrier further based on the quantity of the one or more repetitions on the second carrier being fewer than the quantity of repetitions on the first carrier.

In a ninth aspect, alone or in combination with one or more of the first through eighth aspects, the one or more repetitions of the PUCCH signal are monitored for on the second carrier further based on the quantity of the one or more repetitions on the second carrier satisfying a threshold percentage of the quantity of repetitions on the first carrier.

In a tenth aspect, alone or in combination with one or more of the first through ninth aspects, the one or more repetitions on the second carrier are monitored for at an earliest available slot or sub-slot on the second carrier.

In an eleventh aspect, alone or in combination with one or more of the first through tenth aspects, the one or more repetitions of the PUCCH signal are monitored for on the second carrier further based on a second or later repetition, of the one or more repetitions, on the second carrier being scheduled earlier in time than a corresponding repetition on the first carrier.

In a twelfth aspect, alone or in combination with one or more of the first through eleventh aspects, the one or more repetitions of the PUCCH signal are monitored for on the second carrier further based on a repetition that satisfies a time threshold associated with a first repetition, of the one or more repetitions, on the second carrier being scheduled earlier in time than a corresponding repetition on the first carrier.

In a thirteenth aspect, alone or in combination with one or more of the first through twelfth aspects, the one or more repetitions of the PUCCH signal are monitored for on the second carrier further based on a repetition type associated with the first carrier matching a repetition type associated with the second carrier.

In a fourteenth aspect, alone or in combination with one or more of the first through thirteenth aspects, the one or more repetitions of the PUCCH signal are monitored for on the second carrier further based on the first carrier being associated with repetition type A and the second carrier being associated with repetition type B.

In a fifteenth aspect, alone or in combination with one or more of the first through fourteenth aspects, the one or more repetitions of the PUCCH signal are monitored for on the second carrier further based on the first carrier being associated with repetition type A per sub-slot and the second carrier being associated with repetition type A per slot.

In a sixteenth aspect, alone or in combination with one or more of the first through fifteenth aspects, a first portion of the one or more repetitions of the PUCCH signal are monitored for on the second carrier using repetition type A and a second portion of the one or more repetitions of the PUCCH signal are transmitted on the second carrier using repetition type B.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication. The apparatus 1100 may be a UE, or a UE may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, an RU, or another wireless communication device) using the reception component 1102 and the transmission component 1104. As further shown, the apparatus 1100 may include the communication manager 140. The communication manager 140 may include one or more of a determination component 1108 and/or a carrier switching component 1110, among other examples.

In some aspects, the apparatus 1100 may be configured to perform one or more operations described herein in connection with FIGS. 4-8. Additionally, or alternatively, the apparatus 1100 may be configured to perform one or more processes described herein, such as process 900 of FIG. 9, or a combination thereof. In some aspects, the apparatus 1100 and/or one or more components shown in FIG. 11 may include one or more components of the UE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the UE described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the UE described in connection with FIG. 2. In some aspects, the transmission component 1104 may be co-located with the reception component 1102 in a transceiver.

In some aspects, the reception component 1102 may receive a configuration message indicating to switch carriers for a PUCCH. Accordingly, the transmission component 1104 may transmit one or more repetitions of a PUCCH signal on a second carrier rather than a first carrier based on a final repetition, of the one or more repetitions, on the second carrier being scheduled earlier in time than a final repetition on the first carrier. For example, the carrier switching component 1110 may transmit one or more signals to the transmission component 1104 to reconfigure the transmission component 1104 for transmitting on the second carrier rather than the first carrier. The carrier switching component 1110 may include a modem, a modulator, a transmit MIMO processor, a transmit processor, a controller/processor, a memory, or a combination thereof, of the UE described in connection with FIG. 2.

In some aspects, the reception component 1102 may further receive at least one of a control element or DCI that activates carrier switching on the PUCCH.

In some aspects, the determination component 1108 may determine a quantity of the one or more repetitions on the second carrier based on a quantity of repetitions on the first carrier, an SCS associated with the second carrier, and an SCS associated with the first carrier. The determination component 1108 may include a transmit MIMO processor, a transmit processor, a MIMO detector, a receive processor, a controller/processor, a memory, or a combination thereof, of the UE described in connection with FIG. 2. Accordingly, the transmission component 1104 may transmit one or more repetitions of a PUCCH signal on the second carrier further based on the quantity of the one or more repetitions on the second carrier.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication. The apparatus 1200 may be a network node, or a network node may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, an RU, or another wireless communication device) using the reception component 1202 and the transmission component 1204. As further shown, the apparatus 1200 may include the communication manager 150. The communication manager 150 may include one or more of a monitoring component 1208, a determination component 1210, or a configuration component 1212, among other examples.

In some aspects, the apparatus 1200 may be configured to perform one or more operations described herein in connection with FIGS. 4-8. Additionally, or alternatively, the apparatus 1200 may be configured to perform one or more processes described herein, such as process 1000 of FIG. 10, or a combination thereof. In some aspects, the apparatus 1200 and/or one or more components shown in FIG. 12 may include one or more components of the network node described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the network node described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the network node described in connection with FIG. 2. In some aspects, the transmission component 1204 may be co-located with the reception component 1202 in a transceiver.

In some aspects, the transmission component 1204 may transmit a configuration message indicating to switch carriers for a PUCCH. For example, the configuration component 1212 may configure carrier switching for a UE and generate the configuration message. The configuration component 1212 may include a transmit MIMO processor, a transmit processor, a MIMO detector, a receive processor, a controller/processor, a memory, or a combination thereof, of the network node described in connection with FIG. 2. Accordingly, the monitoring component 1208 may monitor for one or more repetitions of a PUCCH signal on a second carrier rather than a first carrier based on a final repetition, of the one or more repetitions, on the second carrier being scheduled earlier in time than a final repetition on the first carrier. The monitoring component 1208 may include one or more antennas, a modem, a demodulator, a MIMO detector, a receive processor, a controller/processor, a memory, or a combination thereof, of the network node described in connection with FIG. 2.

In some aspects, the transmission component 1204 may further transmit at least one of a control element or DCI that activates carrier switching on the PUCCH.

In some aspects, the determination component 1210 may determine a quantity of the one or more repetitions on the second carrier based on a quantity of repetitions on the first carrier, an SCS associated with the second carrier, and an SCS associated with the first carrier. The determination component 1210 may include a transmit MIMO processor, a transmit processor, a MIMO detector, a receive processor, a controller/processor, a memory, or a combination thereof, of the network node described in connection with FIG. 2. Accordingly, the monitoring component 1208 may monitor for one or more repetitions of a PUCCH signal on the second carrier further based on the quantity of the one or more repetitions on the second carrier.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a user equipment (UE), comprising: receiving, from a network, a configuration message indicating to switch carriers for a physical uplink control channel (PUCCH); and transmitting one or more repetitions of a PUCCH signal on a second carrier rather than a first carrier based on a final repetition, of the one or more repetitions, on the second carrier being scheduled earlier in time than a final repetition on the first carrier.

Aspect 2: The method of Aspect 1, wherein the configuration message comprises a radio resource control (RRC) message.

Aspect 3: The method of any of Aspects 1 through 2, further comprising: receiving at least one of a control element or downlink control information (DCI) that activates carrier switching on the PUCCH.

Aspect 4: The method of any of Aspects 1 through 3, wherein the PUCCH signal comprises one or more hybrid automatic repeat request (HARD) feedback signals.

Aspect 5: The method of any of Aspects 1 through 4, wherein the one or more repetitions of the PUCCH signal are transmitted on the second carrier further based on a quantity of PUCCH resources on the second carrier satisfying a threshold.

Aspect 6: The method of Aspect 5, wherein the threshold is based on a percentage of a quantity of repetitions on the first carrier.

Aspect 7: The method of any of Aspects 1 through 6, further comprising: determining a quantity of the one or more repetitions on the second carrier based on a quantity of repetitions on the first carrier, a subcarrier spacing (SCS) associated with the second carrier, and an SCS associated with the first carrier.

Aspect 8: The method of Aspect 7, wherein the one or more repetitions of the PUCCH signal are transmitted on the second carrier further based on the quantity of the one or more repetitions on the second carrier being fewer than the quantity of repetitions on the first carrier.

Aspect 9: The method of any of Aspects 7 through 8, wherein the one or more repetitions of the PUCCH signal are transmitted on the second carrier further based on the quantity of the one or more repetitions on the second carrier satisfying a threshold percentage of the quantity of repetitions on the first carrier.

Aspect 10: The method of any of Aspects 1 through 9, wherein the one or more repetitions on the second carrier are transmitted at an earliest available slot or sub-slot on the second carrier.

Aspect 11: The method of any of Aspects 1 through 10, wherein the one or more repetitions of the PUCCH signal are transmitted on the second carrier further based on a first repetition, of the one or more repetitions, on the second carrier being scheduled earlier in time than a first repetition on the first carrier.

Aspect 12: The method of any of Aspects 1 through 10, wherein the one or more repetitions of the PUCCH signal are transmitted on the second carrier further based on a second or later repetition, of the one or more repetitions, on the second carrier being scheduled earlier in time than a corresponding repetition on the first carrier.

Aspect 13: The method of any of Aspects 1 through 10, wherein the one or more repetitions of the PUCCH signal are transmitted on the second carrier further based on a repetition that satisfies a time threshold associated with a first repetition, of the one or more repetitions, on the second carrier being scheduled earlier in time than a corresponding repetition on the first carrier.

Aspect 14: The method of any of Aspects 1 through 13, wherein the one or more repetitions of the PUCCH signal are transmitted on the second carrier further based on a repetition type associated with the first carrier matching a repetition type associated with the second carrier.

Aspect 15: The method of any of Aspects 1 through 13, wherein the one or more repetitions of the PUCCH signal are transmitted on the second carrier further based on the first carrier being associated with repetition type A and the second carrier being associated with repetition type B.

Aspect 16: The method of any of Aspects 1 through 13, wherein the one or more repetitions of the PUCCH signal are transmitted on the second carrier further based on the first carrier being associated with repetition type A per sub-slot and the second carrier being associated with repetition type A per slot.

Aspect 17: The method of any of Aspects 1 through 13, wherein a first portion of the one or more repetitions of the PUCCH signal are transmitted on the second carrier using repetition type A and a second portion of the one or more repetitions of the PUCCH signal are transmitted on the second carrier using repetition type B.

Aspect 18: A method of wireless communication performed by one or more network cells, comprising: transmitting a configuration message indicating to switch carriers for a physical uplink control channel (PUCCH); and monitoring for one or more repetitions of a PUCCH signal on a second carrier rather than a first carrier based on a final repetition, of the one or more repetitions, on the second carrier being scheduled earlier in time than a final repetition on the first carrier.

Aspect 19: The method of Aspect 18, wherein the configuration message comprises a radio resource control (RRC) message.

Aspect 20: The method of any of Aspects 18 through 19, further comprising: transmitting at least one of a control element or downlink control information (DCI) that activates carrier switching on the PUCCH.

Aspect 21: The method of any of Aspects 18 through 20, wherein the PUCCH signal comprises one or more hybrid automatic repeat request (HARD) feedback signals.

Aspect 22: The method of any of Aspects 18 through 21, wherein the one or more repetitions of the PUCCH signal are monitored for on the second carrier further based on a quantity of PUCCH resources on the second carrier satisfying a threshold.

Aspect 23: The method of Aspect 22, wherein the threshold is based on a percentage of a quantity of repetitions on the first carrier.

Aspect 24: The method of any of Aspects 18 through 23, further comprising: determining a quantity of the one or more repetitions on the second carrier based on a quantity of repetitions on the first carrier, a subcarrier spacing (SCS) associated with the second carrier, and an SCS associated with the first carrier.

Aspect 25: The method of Aspect 24, wherein the one or more repetitions of the PUCCH signal are monitored for on the second carrier further based on the quantity of the one or more repetitions on the second carrier being fewer than the quantity of repetitions on the first carrier.

Aspect 26: The method of any of Aspects 24 through 25, wherein the one or more repetitions of the PUCCH signal are monitored for on the second carrier further based on the quantity of the one or more repetitions on the second carrier satisfying a threshold percentage of the quantity of repetitions on the first carrier.

Aspect 27: The method of any of Aspects 18 through 26, wherein the one or more repetitions on the second carrier are monitored for at an earliest available slot or sub-slot on the second carrier.

Aspect 28: The method of any of Aspects 18 through 27, wherein the one or more repetitions of the PUCCH signal are monitored for on the second carrier further based on a first repetition, of the one or more repetitions, on the second carrier being scheduled earlier in time than a first repetition on the first carrier.

Aspect 29: The method of any of Aspects 18 through 27, wherein the one or more repetitions of the PUCCH signal are monitored for on the second carrier further based on a second or later repetition, of the one or more repetitions, on the second carrier being scheduled earlier in time than a corresponding repetition on the first carrier.

Aspect 30: The method of any of Aspects 18 through 27, wherein the one or more repetitions of the PUCCH signal are monitored for on the second carrier further based on a repetition that satisfies a time threshold associated with a first repetition, of the one or more repetitions, on the second carrier being scheduled earlier in time than a corresponding repetition on the first carrier.

Aspect 31: The method of any of Aspects 18 through 30, wherein the one or more repetitions of the PUCCH signal are monitored for on the second carrier further based on a repetition type associated with the first carrier matching a repetition type associated with the second carrier.

Aspect 32: The method of any of Aspects 18 through 30, wherein the one or more repetitions of the PUCCH signal are monitored for on the second carrier further based on the first carrier being associated with repetition type A and the second carrier being associated with repetition type B.

Aspect 33: The method of any of Aspects 18 through 30, wherein the one or more repetitions of the PUCCH signal are monitored for on the second carrier further based on the first carrier being associated with repetition type A per sub-slot and the second carrier being associated with repetition type A per slot.

Aspect 34: The method of any of Aspects 18 through 30, wherein a first portion of the one or more repetitions of the PUCCH signal are monitored for on the second carrier using repetition type A and a second portion of the one or more repetitions of the PUCCH signal are transmitted on the second carrier using repetition type B.

Aspect 35: An apparatus for wireless communication at a device, comprising a processor; memory coupled with the processor; and instructions stored in the memory and executable by the processor to cause the apparatus to perform the method of one or more of Aspects 1-17.

Aspect 36: A device for wireless communication, comprising a memory and one or more processors coupled to the memory, the one or more processors configured to perform the method of one or more of Aspects 1-17.

Aspect 37: An apparatus for wireless communication, comprising at least one means for performing the method of one or more of Aspects 1-17.

Aspect 38: A non-transitory computer-readable medium storing code for wireless communication, the code comprising instructions executable by a processor to perform the method of one or more of Aspects 1-17.

Aspect 39: A non-transitory computer-readable medium storing a set of instructions for wireless communication, the set of instructions comprising one or more instructions that, when executed by one or more processors of a device, cause the device to perform the method of one or more of Aspects 1-17.

Aspect 40: An apparatus for wireless communication at a device, comprising a processor; memory coupled with the processor; and instructions stored in the memory and executable by the processor to cause the apparatus to perform the method of one or more of Aspects 18-34.

Aspect 41: A device for wireless communication, comprising a memory and one or more processors coupled to the memory, the one or more processors configured to perform the method of one or more of Aspects 18-34.

Aspect 42: An apparatus for wireless communication, comprising at least one means for performing the method of one or more of Aspects 18-34.

Aspect 43: A non-transitory computer-readable medium storing code for wireless communication, the code comprising instructions executable by a processor to perform the method of one or more of Aspects 18-34.

Aspect 44: A non-transitory computer-readable medium storing a set of instructions for wireless communication, the set of instructions comprising one or more instructions that, when executed by one or more processors of a device, cause the device to perform the method of one or more of Aspects 18-34.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors, coupled to the memory, configured to:
receive, from a network, a configuration message indicating to switch carriers for a physical uplink control channel (PUCCH); and
transmit one or more repetitions of a PUCCH signal on a second carrier rather than a first carrier based on a final repetition, of the one or more repetitions, on the second carrier being scheduled earlier in time than a final repetition on the first carrier.

2. The apparatus of claim 1, wherein the configuration message comprises a radio resource control (RRC) message.

3. The apparatus of claim 1, wherein the one or more processors are further configured to:
receive at least one of a control element or downlink control information (DCI) that activates carrier switching on the PUCCH.

4. The apparatus of claim 1, wherein the PUCCH signal comprises one or more hybrid automatic repeat request (HARD) feedback signals.

5. The apparatus of claim 1, wherein the one or more repetitions of the PUCCH signal are transmitted on the second carrier further based on a first repetition, of the one or more repetitions, on the second carrier being scheduled earlier in time than a first repetition on the first carrier.

6. The apparatus of claim 1, wherein the one or more repetitions of the PUCCH signal are transmitted on the second carrier further based on a quantity of PUCCH resources on the second carrier satisfying a threshold.

7. The apparatus of claim 6, wherein the threshold is based on a percentage of a quantity of repetitions on the first carrier.

8. The apparatus of claim 1, wherein the one or more processors are further configured to:
determine a quantity of the one or more repetitions on the second carrier based on a quantity of repetitions on the first carrier, a subcarrier spacing (SCS) associated with the second carrier, and an SCS associated with the first carrier.

9. The apparatus of claim 8, wherein the one or more repetitions of the PUCCH signal are transmitted on the second carrier further based on the quantity of the one or more repetitions on the second carrier being fewer than the quantity of repetitions on the first carrier.

10. The apparatus of claim 8, wherein the one or more repetitions of the PUCCH signal are transmitted on the second carrier further based on the quantity of the one or more repetitions on the second carrier satisfying a threshold percentage of the quantity of repetitions on the first carrier.

11. The apparatus of claim 1, wherein the one or more repetitions on the second carrier are transmitted at an earliest available slot or sub-slot on the second carrier.

12. The apparatus of claim 1, wherein the one or more repetitions of the PUCCH signal are transmitted on the second carrier further based on a second or later repetition, of the one or more repetitions, on the second carrier being scheduled earlier in time than a corresponding repetition on the first carrier.

13. The apparatus of claim 1, wherein the one or more repetitions of the PUCCH signal are transmitted on the second carrier further based on a repetition that satisfies a time threshold associated with a first repetition, of the one or more repetitions, on the second carrier being scheduled earlier in time than a corresponding repetition on the first carrier.

14. The apparatus of claim 1, wherein the one or more repetitions of the PUCCH signal are transmitted on the second carrier further based on a repetition type associated with the first carrier matching a repetition type associated with the second carrier.

15. The apparatus of claim 1, wherein the one or more repetitions of the PUCCH signal are transmitted on the second carrier further based on the first carrier being associated with repetition type A and the second carrier being associated with repetition type B.

16. The apparatus of claim 1, wherein the one or more repetitions of the PUCCH signal are transmitted on the second carrier further based on the first carrier being associated with repetition type A per sub-slot and the second carrier being associated with repetition type A per slot.

17. The apparatus of claim 1, wherein a first portion of the one or more repetitions of the PUCCH signal are transmitted on the second carrier using repetition type A and a second portion of the one or more repetitions of the PUCCH signal are transmitted on the second carrier using repetition type B.

18. An apparatus for wireless communication at one or more network cells, comprising:
a memory; and
one or more processors, coupled to the memory, configured to:
transmit a configuration message indicating to switch carriers for a physical uplink control channel (PUCCH); and
monitor for one or more repetitions of a PUCCH signal on a second carrier rather than a first carrier based on a final repetition, of the one or more repetitions, on the second carrier being scheduled earlier in time than a final repetition on the first carrier.

19. The apparatus of claim 18, wherein the configuration message comprises a radio resource control (RRC) message.

20. The apparatus of claim 18, wherein the one or more processors are further configured to:
transmit at least one of a control element or downlink control information (DCI) that activates carrier switching on the PUCCH.

21. The apparatus of claim 18, wherein the PUCCH signal comprises one or more hybrid automatic repeat request (HARQ) feedback signals.

22. The apparatus of claim 18, wherein the one or more repetitions of the PUCCH signal are monitored for on the second carrier further based on a first repetition, of the one or more repetitions, on the second carrier being scheduled earlier in time than a first repetition on the first carrier.

23. The apparatus of claim 18, wherein the one or more repetitions of the PUCCH signal are monitored for on the second carrier further based on a quantity of PUCCH resources on the second carrier satisfying a threshold.

24. The apparatus of claim 23, wherein the threshold is based on a percentage of a quantity of repetitions on the first carrier.

25. The apparatus of claim 18, wherein the one or more processors are further configured to:
determine a quantity of the one or more repetitions on the second carrier based on a quantity of repetitions on the first carrier, a subcarrier spacing (SCS) associated with the second carrier, and an SCS associated with the first carrier.

26. The apparatus of claim 25, wherein the one or more repetitions of the PUCCH signal are monitored for on the second carrier further based on the quantity of the one or more repetitions on the second carrier being fewer than the quantity of repetitions on the first carrier.

27. The apparatus of claim 25, wherein the one or more repetitions of the PUCCH signal are monitored for on the second carrier further based on the quantity of the one or more repetitions on the second carrier satisfying a threshold percentage of the quantity of repetitions on the first carrier.

28. The apparatus of claim 18, wherein the one or more repetitions on the second carrier are monitored for at an earliest available slot or sub-slot on the second carrier.

29. A method of wireless communication performed by a user equipment (UE), comprising:
receiving, from a network, a configuration message indicating to switch carriers for a physical uplink control channel (PUCCH); and
transmitting one or more repetitions of a PUCCH signal on a second carrier rather than a first carrier based on a final repetition, of the one or more repetitions, on the second carrier being scheduled earlier in time than a final repetition on the first carrier.

30. A method of wireless communication performed by one or more network cells, comprising:
transmitting a configuration message indicating to switch carriers for a physical uplink control channel (PUCCH); and
monitoring for one or more repetitions of a PUCCH signal on a second carrier rather than a first carrier based on a final repetition, of the one or more repetitions, on the second carrier being scheduled earlier in time than a final repetition on the first carrier.
